(19) United States
(12) Patent Application Publication
(10) Pub. No.: US 2020/0342469 A1
(43) Pub. Date: Oct. 29, 2020

(54) SYSTEM AND METHOD FOR PERFORMING A QUALITY ASSESSMENT BY SEGMENTING AND ANALYZING VERBATIMS

(71) Applicant: Quality Data Management, Inc., Broadview Heights, OH (US)

(72) Inventor: Clinton L. Packer, Sagamore Hills, OH (US)

(21) Appl. No.: 16/912,919

(22) Filed: Jun. 26, 2020

Related U.S. Application Data
(63) Continuation of application No. 15/218,349, filed on Jul. 25, 2016, now abandoned.
(60) Provisional application No. 62/196,060, filed on Jul. 23, 2015.

(51) Int. Cl. G06Q 30/02

(52) U.S. Cl. CPC G06Q 30/0202; G06Q 30/0282; G06Q 30/0203

(57) ABSTRACT

A system and method which offers organizations a way to analyze customer verbatims to understand their customers perceptions of their products and/or services, and to provide a mechanism to assess customer loyalty based on the actual comments provided by customers in their own language (as opposed to lengthier, more expensive static surveys).

### CROSS-REFERENCES TO RELATED APPLICATIONS

This is a continuation of U.S. patent application Ser. No. 15/218,349, filed on Jul. 25, 2016, which claims the benefit of U.S. provisional application Ser. No. 62/196,060 filed on Jul. 23, 2015, the entireties of which are incorporated herein by reference.

### BACKGROUND

Conventional approaches for determining customer satisfaction are often cumbersome and time consuming, such as by using detailed questionnaires that customers don't enjoy completing, and hence that may not gather accurate, or sufficient, information. It is desirable to better determine customer perceptions of products and/or services to assess customer loyalty in a more practical and time efficient manner.

### SUMMARY

Provided are a plurality of example embodiments, including, but not limited to, a system comprising a computer system including at least one server and at least one database, said computer system for performing a method for evaluating the quality of a product or service, said method comprising the steps of:

provide a plurality of verbatims obtained from a plurality of customers;

automatically segment said verbatims;

automatically categorize said verbatims;

automatically assign a numerical value to each segment to give each segment a segment rating;

automatically convert each segment rating to a score;

automatically determine a degree in which expectations are met based on the scores;

automatically determine a likelihood for customers to recommend the product or service; and

automatically generate a report for reporting on the degree in which customer expectations are met.

Also provided is a system comprising a computer system including at least one server and at least one database, said computer system for performing a method for evaluating the quality of a product or service, said method comprising the steps of:

providing one or more user interfaces for obtaining verbatims from a plurality of customers;

converting said verbatims into electronic form;

automatically segmenting said verbatims;

categorizing the segmented verbatims;

assigning a numerical value to each segment to give each segment a segment rating;

converting each segment rating to a score;

identifying drivers of loyalty and their degree of influence based on the segment sores;

for each segment, automatically determining whether the segment is actionable;

determining a degree in which expectations are met based on the scores;

determining likelihood for customers to recommend the product or service.

Still further provided is a system comprising a computer system including at least one server and at least one database, said computer system for performing a method for evaluating the quality of a product or service, said method comprising the steps of:

provide one or more user interfaces for obtaining verbatims from a plurality of customers;

converting said verbatims into electronic form;

automatically segment a subset of said verbatims;

initially automatically categorize the segmented subset of verbatims;

validate and update the initial categorization of the subset of verbatims to ensure consistency;

automatically segment the verbatims not provided in said subset;

automatically provide a final categorization of all verbatims based on the validated and updated categorization;

assign a numerical value to each segment to give each segment a segment rating;

convert each segment rating to a score;

identify drivers of loyalty and their degree of influence based on the segment sores;

for each segment, automatically determine whether the segment is actionable;

determine a degree in which expectations are met based on the scores;

determine a likelihood for customers to recommend the product or service; and

generate a report for reporting on the categorizations of the verbatims, their scores and/or their degree of influence, the degree in which customer expectations are met and their likelihood to recommend.

Also provided are additional example embodiments, some, but not all of which, are described herein below in more detail.

### BRIEF DESCRIPTION OF THE DRAWINGS

The features and advantages of the example embodiments described herein will become apparent to those skilled in the art to which this disclosure relates upon reading the following description, with reference to the accompanying drawings, in which:

FIG. 1 is a flow chart showing example steps for implementing the example methodology;

FIG. 2 is diagram showing a high-level example system for implementing the disclosed methodology;

FIG. 2A shows a hardware diagram for an example hardware implementation for the system of FIG. 2;

FIG. 3 is a diagram showing an example domain category and subcategory validation process; and

FIG. 4 is a photograph of results of multiple linear regression for example verbatims for an example physician office visit.

### DETAILED DESCRIPTION OF THE EXAMPLE EMBODIMENTS

Provided is a system and method which offers organizations a way to better understand their customers perceptions of their products and/or services, and to provide a mechanism to assess customer loyalty based on the actual comments provided by customers in their own language (as opposed to lengthier, more expensive static surveys).

The disclosed Product Solution uses Natural Language Modeling (NLM) to analyze respondent responses to open-ended questions regarding personal experience with a product or service. Such responses are called “verbatims.” This process provides an analytic technique which synthesizes verbatim responses into “actionable” data that identify positive and negative attributes of the respondent's experience. Through these types of analyses, the voice of the individual respondent communicates at least four types of information that can be used to understand and improve the respondent's experience. These include:

(1) The respondents evaluation of the received product's or service's performance; (2) The extent to which the products or services met their expectations; (3) Predictions of the extent to which individuals would recommend the products/services to their family and/or friends; and (4) Prioritization of improvement opportunities.

Example Benefits:

Cost: Costs are greatly reduced (e.g., by 25% or more) of the price of a standard survey, and still can be profitable to providers;

Better insight into people's perceptions: Standard surveys ask a set of prescribed predetermined questions relating to prescribed topics. In contrast, comments according to the disclosed approach can be open-ended and thus get to the heart of the individual, allowing the individual to discuss what is most important to them in their own words (e.g., verbatims). This technique enables users to obtain as much information as from a standard, 40-item survey using less time and effort and at lower cost.

Actionable: Results be used to identify both strengths and opportunity for improvement for a business or organization utilizing the results of the process.

Reporting: Results are summarized in easy-to-understand reports, including opportunities for improvement prioritized by impact on loyalty.

Flexibility: This methodology can be used to analyze comments from virtually any source for virtually any topic or industry.

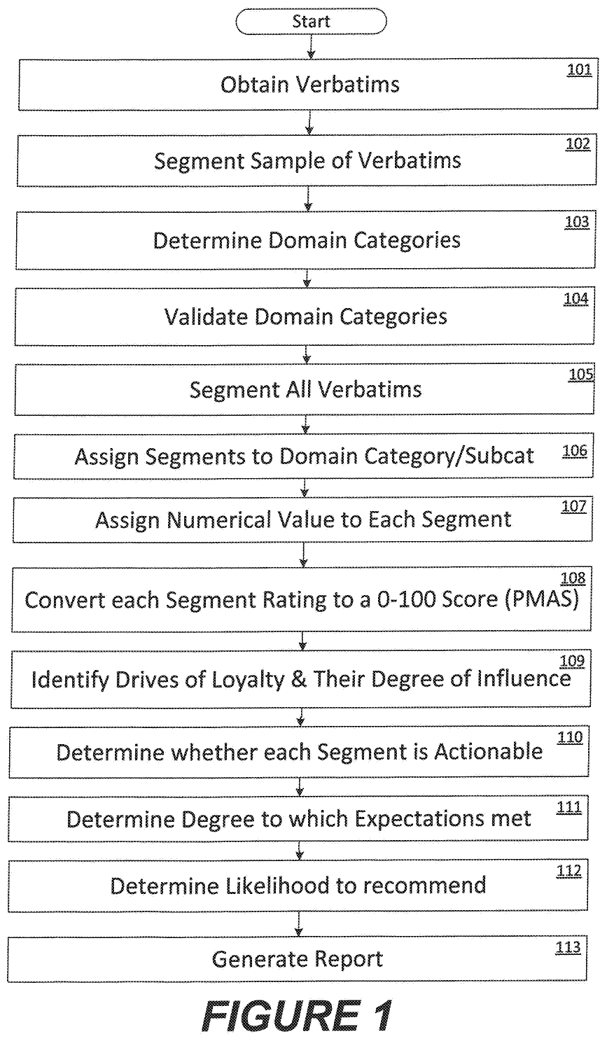

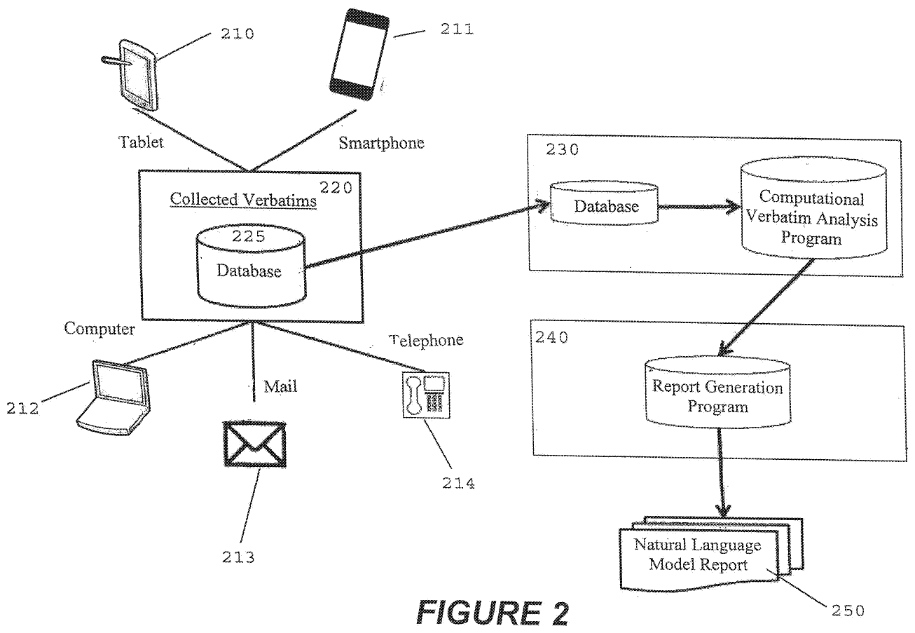

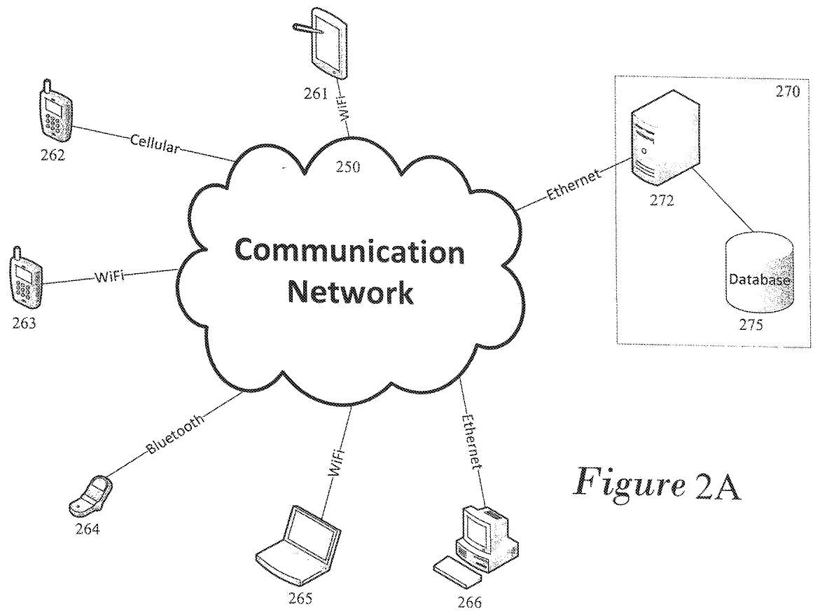

To achieve the above and other benefits, the methodology performs the steps as shown in FIG. 1 using the technical infrastructure that is shown in FIG. 2.

Manual v. Automated Processes

Referring again to FIG. 1, as soon as verbatims are put into machine-readable format, step 101 (which may be by direct entry of the user by speech or typing or some other input format, or by converting paper or other format verbatims obtained in step 101 into electronic form such as through an OCR process, for example), each subsequent step (i.e., each of steps 102-113) is fully automated by using specialized programming of a server and database, or other computing devices, using a system as shown in in FIG. 2, which can be arranged in a hardware infrastructure such as shown in FIG. 2A, both described in more detail herein below. Typically, the only manual intervention that is provided is for quality assurance audits (validating computer-generated domain categories and subcategories, such as in Step 104, and auditing the reports automatically generated in Step 113).

Step 101: Obtain verbatims: The natural language model can process verbatims from a variety of sources, including comments from surveys collected on various media, including but not limited to: paper, phone inputs (audio), Web forms, tablet inputs, or by smartphone, for example. Ultimately, the verbatims are provided or converted into an electronic format, and the question that leads to the resulting verbatim is utilized.

Step 102: Segment sample verbatims: A sample of a number of verbatims, such as 100 verbatims, for example, is taken. Each sample verbatim is segmented into separate logical components, with each segment representing a single thought. First, the segmentation should respond to clause construction (e.g. periods and words like “and” or “but”). Other examples are shown below (note—while these and subsequent examples are from healthcare, the process and methods apply to other industries, products and services as well):

Verbatim: “The doctor was very kind and caring, but the receptionist was rude.”

Segmentation:
“The doctor was very kind and caring.”
“The receptionist was rude.”

Verbatim: “The doctor was very kind and caring, and he listened to me about my problems and explained everything very well.”

Segmentation:
“The doctor was very kind and caring.”
“He listened to me about my problems.”
“He explained everything very well.”

Further, break down any compound sentences into a set of “syllogisms” reflecting adjectives that describe several attributes. For example:

Verbatim: “I was absolutely delighted with how down to earth he was, how caring he seemed to be, how personable he was, and how he answered everything I was concerned about.”

Segmentation:
“I was absolutely delighted with how down to earth he was.”
“I was absolutely delighted with how caring he seemed to be.”
“I was absolutely delighted with how personable he was.”
“I was absolutely delighted with how he answered everything I was concerned about.”

Verbatim: “The nurses and doctors were kind and considerate.”

Segmentation:
“The nurses were kind.”
“The nurses were considerate.”
“The doctors were kind.”
“The doctors were considerate.”

A segment is any clause, phrase, sentence, or group of sentences that express a single thought or topic. So, a segment can be more than a single sentence, or a fragment of the sentence.

Step 103: Review verbatims to determine domain categories and subcategories: There can be multiple levels of categories and subcategories, depending on the topic. For example, for physician office visits, there can be two main categories: Staff and Process. Under Staff, for example, there can be subcategories Physician, Nurse, etc. Under Physician there can be multiple subcategories such as Respect, Knowledge, etc. The lowest level of subcategory (i.e. most granular) is called a Topic. There are typically 2-4 layers of categories and subcategories (although other numbers can be used). The process operates the verbatims against the computational verbatim analysis program code to determine the initial categories and subcategories.

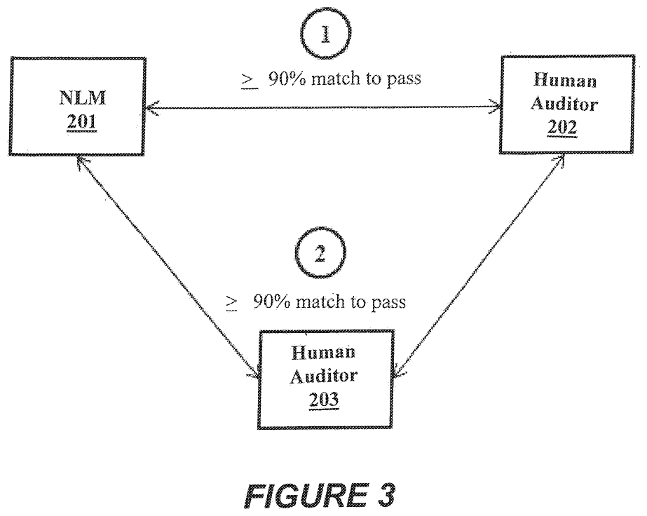

Step 104: Validate domain categories and subcategories: The process of FIG. 3, showing the “Domain category and subcategory validation process,” can be used to validate the categories and subcategories by the method provided below:

Have two separate processes (the NLM program 201 and a human auditor 202) classify a sample (100-200) of segments from Step 102 above into categories. Compare the results of both parties. If less than 90% of the classifications agree, revise the program code in Step 103 above as needed and repeat Step 103.

If at least 90% of the classifications agree, then have a second human auditor 203 classify the sample of segments. If those results agree with 90% of the results from each of the two original processes, move to Step 104.

If less than 90% of the classifications agree, revise the program code in Step 103 above as needed and repeat Step 103. Repeat Step 104 until at least 90% of the classifications agree.

Now, referring back to FIG. 1:

Step 105: Segment all verbatims: Segment the remainder of the verbatims using the process outlined in Step 102, now that the process has been refined using the sample verbatims.

Step 106: Assign segments to domain category/subcategory: Now that the categories and topics have been identified, each graded segment can be assigned to a category/subcategory (or “Other” if it cannot be classified into an existing category).

Step 107: Assign numerical value to each segment: Each segment should be assigned a numerical grade. As an example, a grade can be a number from 1 to 5 that describes how positive each segment is. For such an example, the numerical grade is 1 (enthusiastically positive), 2 (positive but not enthusiastic), 3 (neutral), 4 (negative but not emphatic) and 5 (emphatically negative). Of course, different ranges of numbers can be used as desired.

Generally speaking, an enthusiastic or emphatic verbatim segment will have a superlative word or phrase, such as “very” or “wonderful” or “worst I've ever seen” or “awful” in it. Verbatims that are ambiguous (e.g. a statement that is not related to an emotion such as caring, or it cannot be determined whether the statement is positive or negative) are assigned a grade of “NA”. Below are examples for each type of grade for the Example grading scheme provided above. (NOTE: These and subsequent examples apply to physician office visits, but the principles apply to not only other health care settings but also other industries, including both products and services.)

Grade 1—(Enthusiastically Positive):
“I received excellent care in the emergency room”
“paramedics were awesome—very friendly”
“these people are wonderful”
“His credentials are outstanding and he is clearly one of the top shoulder surgeons globally.”
“He's as knowledgeable as I have ever heard a doctor be about the condition that I had with my shoulder.”

Grade 2—(Positive But Not Enthusiastic):
“He is good at what he does”
“He talks so I could understand him”
“good follow-up”
“He was good to talk to”
“staff was courteous”
“the staff was friendly”

Grade 3—(Neutral):
“He didn't disappoint me. He was alright.”
“The care was alright.”
“They're okay. Not bad.”
“I would say he's okay.”
“I can't complain”

Grade 4—(Negative But Not Emphatic)
“I was disappointed in his attitude”
“the wait was a little long”
“He could have spent more time with me”
“I felt she could have probed a little further to figure out if there was some underlying reason for my condition”
“I don't feel I had enough contact with doctor”
“The doctor was rude”
“I felt he was not a good listener”
“lack of communication amongst staff”
“bedside manner needs improvement”

Grade 5—(Emphatically Negative)
“Very disappointing”
“The doctor's attitude sucked”
“I've never seen such unprofessional people in all my life”
“floors are filthy”
“this doctor was terrible”
“the doctor treated me like crap”

NA (Indeterminate or ambiguous). This is used when it can't be determined whether the comment is positive or negative, or where it's not related to the care process or provider. Examples:
Question: “What delighted or disappointed you about this doctor?”
   Comment: “His attitude” (can't tell whether the patient was delighted or disappointed);
or
   Comment: “Traffic was terrible and it took me an hour to get there” (not related to the care process or provider);

Step 108: Convert each segment rating to a 0-100 score: The formula for converting the raw score (Rs) to a percent maximum achievable score (“PMAS”) is:

PMAS=(5−Rs)×25

So a raw score of 1 corresponds to a PMAS of 100; a raw score of 2 corresponds to a PMAS of 75, etc.

Step 109: Identify drivers of loyalty and their degree of influence. A multiple regression analysis is performed on the data, with one dependent variable and 2T independent variables (called “predictor variables”), where T is the number of topics. The dependent variable comes from a rating question (e.g. a question with a response choice of 0-10) that is available from the survey results.

The reason that there are two independent variables per topic is that while we can assign a grade and a PMAS score if the topic comes up in a verbatim, if it is not mentioned, that provides information too. In fact, it is possible to impute a score for segments in which the topic was not mentioned. Thus, each topic has two predictor variables, one representing instances when it is mentioned (and can be assigned a PMAS value from 0-100) and one representing instances when it is not. To impute the values of the unmentioned independent variables (i.e. “missing”), we start with the hypothesis that the average score in instances where it is not mentioned is 50 (i.e. the PMAS for neutral segments, where the individual is neither delighted nor disappointed). We then modify it by using the following formula:

“Missing” value=50+(coefficient-unmentioned)/(coefficient-mentioned)

The following steps are used to determine drivers and degree of influence:

(1) Edit the topics so that each one has enough data points to be analyzable. (E.g. if a topic only has a couple of observations, eliminate it, since it won't yield any useful information.); (2) Divide the data into separate records for each segment; (3) Apply (i.e. link) the global rating to each segment; and (4) Apply the multiple regression as described above, with 2T independent variables and one dependent variable. An example is shown below (the verbatims were related to physician office visits).

In this particular example model (relating to physician office visits), it was started with 72 predictor variables. These consist of 36 variables representing topics when they were mentioned (labeled PMAS1, PMAS2, etc.) and a corresponding 36 variables representing instances where they were not mentioned (u1, u2, etc.). Note that some predictor variables were subsequently eliminated due to collinearity. (Collinearity refers to predictor variables that are dependent on other variables, and thus not independent.)

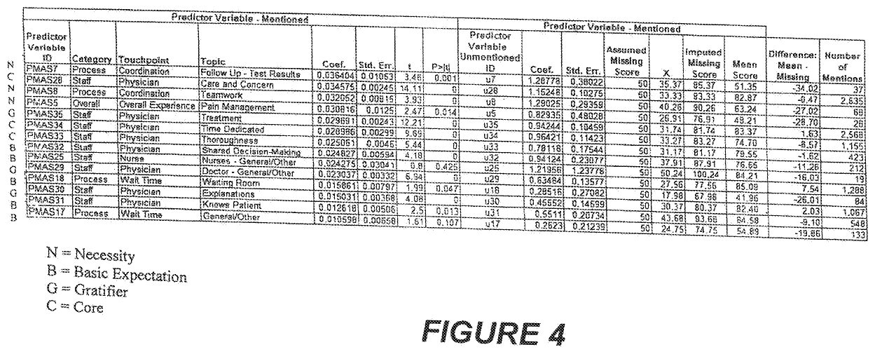

The results of this example physician office visit model are shown in FIG. 4, “Results of multiple linear regression for physician office visit verbatims.” There are 14 variables listed. The coefficient is the impact on the dependent variable of a 1-point improvement in that driver, as determined by the multiple linear regression. For example, a one point improvement in “Follow Up—Test Results” would mean the 0-10 score would go up by 0.036404 points.

In order to determine whether the coefficient is significant, a t test is performed. The null hypothesis is that the coefficient is zero. The column “P>|t|” is the probability of getting a t-value with a higher absolute value if the null hypothesis is true, that is, the coefficient is really zero. For example, the t-value for the coefficient for “Follow Up—Test Results” is 3.46; the probability of getting a higher t-value if the coefficient is really zero is 0.001, or 0.1%. Generally, 0.05 is used as a cutoff. However, judgment must be used when deciding whether a topic is a driver or not. For example, even though Nurse—General/Other only had 19 mentions, and the p-value is 0.425, the difference between the mean and imputed missing score is large enough to be a driver.

As described above, one can impute the average score for instances where the topic is not mentioned. Starting with the hypothesis that the average score in instances where it is not mentioned is 50 (i.e. the PMAS for neutral segments, where the patient is neither delighted nor disappointed). Then, modifying it by using the following formula:

“Missing” value=50+(coefficient-unmentioned)/(coefficient-mentioned)

As an example, look at “Follow Up—Test Results”. The coefficient for the mentioned variable is 0.036404. The unmentioned coefficient is 1.28778. So, the “missing” value is: 50+1.28778/0.036404=85.37. This calculation is performed for each predictor variable.

Typically, there are four types of needs for any product or service: Necessities; Basic Expectations; Gratifiers; and Core needs.

“Necessities” are typically taken for granted, and noticeable by their absence. If these attributes are missing or performance is low, that can be a strong dissatisfier. An example is safety. If a product or service is unsafe, people will be highly dissatisfied.

“Basic Expectations” are similar to Necessities in that they are, as the name implies, expected, and absence or low performance on these attributes can be dissatisfiers, but not to the degree of missing or poorly performing Necessity attributes.

“Gratifiers” are attributes such that the higher the level of performance on these needs, the higher satisfaction will be. Examples include frequent checking on diners in a restaurant to see if they would like anything else, or frequent nurse rounding in a hospital to see if there is anything that they could do for the patient.

“Core needs” are not from a statistical standpoint drivers of satisfaction and loyalty, but because they are a core part of the product or service, they are highly correlated with global rating measures.

Necessities can be identified by comparing the imputed “missing” value to the mean score when the topic is mentioned. If the mean score minus the imputed missing score is a large negative number, then it means that when that item is mentioned it is because performance is low or that the attribute is missing. For example, “Follow Up—Test Results” is a Necessity; it is primarily noticed when absent. Necessities are shaded orange in FIG. 4.

In this analysis, several topics had a large negative difference between mean score and imputed missing value, but the coefficients were too low to consider them Necessities. That is, improvement in those areas had a too low of an impact on the 0-10 item to be considered Necessities. However, the large negative differences between mean score and imputed missing values indicate that they represent Basic Expectations (shaded yellow in FIG. 4).

Gratifiers, on the other hand, are identifiable when the difference between mean score and imputed missing value is positive. In this case, Gratifier topics are shaded in green in FIG. 4.

Returning to FIG. 1:

Step 110: Determine whether each segment is “actionable”: This is done by categorizing each segment as Actionable or Non-Actionable. An Actionable segment describes not only the quality, but is also something that can be addressed through an improvement initiative. (It can also be used to determine Delight factors in the case of enthusiastically positive comments.) NOTE: an Actionable segment may or may not give a concrete example of what makes it that way. For example, if the respondent says “The doctor was excellent” we have no way to know what that means, so it is Non-Actionable. (We can't tell someone to “be excellent”—what would they do to accomplish that?) But if the respondent says, “The doctor had poor communication skills,” then we can intervene by helping him/her improve his/her communication skills (and there are several known best practices and classes). So an Actionable segment gives enough information to tell concretely what needs to improve (or is being performed well); it doesn't have to tell how.

One way to think of Actionable is that it is indicative of a method, skill, quality, or personal trait that can be taught or learned. Ask yourself: “Can the issue at hand be taught in a seminar, training class or customer service workshop?” Another related question would be: “Could the service provider read a self-help book on the issue?”

Another way to think of Actionable is by asking if it refers to something that an administrator could say to an employee: “Do that.” For example, be polite, be courteous, be efficient, don't keep people waiting, be organized, be thorough, take time to listen, answer all questions, demonstrate team work, be friendly, and be respectful.

Segments would be Non-Actionable if they are vague generalities such as—he was great, she was good, everything was fine.

Non-Actionable can be thought of as indicative of something too general or vague to describe as a method, skill, quality, or personal trait, and thus it cannot be readily identified as something that can be taught or learned.

If segment is a compliment, ask what the converse would be classified as. For example, if the segment states, “I didn't have to wait at all”, the converse would be, “I had to wait too long”, which is Actionable since workflow/process improvements can address this.

Furthermore, a single word can change a segment from Non-Actionable to Actionable. An example is, “He was nice.” That's non-specific, because it's too vague. “He treated me nice” [sic] now is actionable, since it refers to how a patient was treated by the attendee. The converse would be, “He didn't treat me nicely”, which could be addressed through customer service training.

Some examples from the healthcare industry follow:

Actionable:
“He gave good advice.” This is actionable because it implies that his medical knowledge is up-to-date; conversely, if he did not give good advice, it would imply he is not up-to-date with current guidelines. This could be remedied by reading current literature, Internet, conferences, etc.
“The doctor was thorough in his examination.” The doctor listened well.” Thoroughness as a “best practice” of patient examination and listening skills can both be taught.
“The doctor had a great sense of humor.” One can learn to be humorous or develop a sense of humor.
“The doctor is always running late.” Time management skills and process redesign skills can be learned.
“The wait was too long in the waiting room.” Workflow/process improvement methods can be implemented.
“The nurse was rude”. Social/interpersonal skills can be taught and implemented.
“He explains things well.” The converse is, “he doesn't explain things well” can be improved through communication training/workshops.
“He helped me.” This is specific because it's about meeting expectations; the opposite would be “wasn't helpful”. The intervention would be making sure they ask patient for what their goals are for this visit or asking “how can we help?”
“The doctor really eased my mind about my son's condition”. Making the patient comfortable is something that can be addressed making sure they meet the patient's need (see above).

Non-Actionable: Each of these is too general to identify any associated methods, skills, qualities, or personal traits that could be learned or taught:
“He was nice.” Too vague (as opposed to being treated nicely—that reflects good customer service skills.
“The doctor was good.” The converse, “The doctor wasn't very good,” has no real possibility for intervention—he/she can't go back through medical school.
“The office visit was normal.”
“Have been satisfied with my office visits.”
“I didn't like the nurse.”

Step 111: Determine the degree to which expectations are met: The degrees to which expectations are met are based upon PMAS scores of actionable segments. The following classification scheme is used:
Much Better Than Expected: Actionable segment PMAS of 80-100 for that category
Better Than Expected: Actionable segment PMAS of 60-80 for that category
As Expected: Actionable segment PMAS of 40-60 for that category
Worse Than Expected: Actionable segment PMAS of 20-40 for that category
Much Worse Than Expected: Actionable segment PMAS of 0-20 for that category

Human nature suggests that individuals utilizing a product or service have a preconceived expectation for the performance of that product or service. Individuals are most likely to comment on the experience when an expectation goes unmet (expressing disappointment) or when expectations are exceeded (expressing delight). A neutral comment denotes that expectations were met and the individual was neither delighted nor disappointed by the product or service.

An Actionable segment describes not only an aspect or characteristic of the product or service, but is also something that can be addressed through an improvement initiative (if the segment is negative) or shared as a best practice or delight factor (if the segment is positive). Actionable segments typically come in two forms: Negative actionable segments identify times when the product or service is not meeting expectations, resulting in disappointment. Positive actionable segments identify times where the product or service exceeds expectations, resulting in a delighted individual. Actionable segments are used to measure the level to which expectations are met for each driver.

Step 112: Determine likelihood to recommend: To determine likelihood to recommend, determine people's overall perception of the product or service. By determining a power ranking of each discrete thought, based on relative importance, the degree to which individuals would recommend the product or service is determined.

Step 113: Generate report. Reports will be automatically generated by the system: The format and table of contents will be the same for every report; content will auto populate. Results will be presented in a visually intuitive format. Examples of this include, but are not limited to: color-coded pie charts showing distribution of segments by driver category or topic; bar charts with PMAS scores as well as comparative values (e.g. horizontal bars for an individual unit, and a triangle for the comparative); bar charts of degree of expectations met (e.g. vertical bars by topic, with each section of each bar color-coded by degree to which expectations were met for that score range (e.g. red for the score range representing Much Worse than Expected, orange for the score range representing Worse Than Expected, yellow for the score range representing As Expected, light green for the score range representing Better Than Expected, and darker green for the score range representing Much Better Than Expected); and color-coded bar charts color displaying the percent and number of individuals who would recommend or not recommend the product or service as outlined in Step 112 (e.g. each bar colored either darker green, lighter green, yellow, orange or red).

For quality assurance, a human auditor can be used to inspect the report prior to distribution. An example report automatically generated by the disclosed approach is shown in Appendix A, attached hereto and incorporated by reference.

Note that the proposed system greatly improves existing computer system treatment of verbatim surveys by automating and standardizing the analysis of verbal survey results, increasing the ability of surveyors to obtain information from a participant. Rather than answering a series of questions by choosing one of a plurality of predetermined responses, the participant can answer an open-ended question or questions “in his own words”. Instead of classifying verbatim comments into “positive”, “negative” or “mixed” (sentiment analysis), the method greatly improves the ability of a computer to process natural language responses into actionable categories that provide greater insight into individuals' experiences and perspectives in interacting with a business or individual or group.

FIG. 2 shows an overview of an example system for implementing the methodology described herein. A survey collection subsystem 220 collects a plurality of verbatims for storing in a database 225. The verbatims can be collected from any of many different source devices used by the respondent (e.g., the customer), such as a tablet computer 210, a smartphone 211, a computer 212, by mail or email 215, or by telephone 214, for example. Or devices might be provided by the provider, such as a tablet computer at their office, for example. The source devices can connect to the system 220, 230, 240 by a communication interface, such as the Internet, for example, or directly via Ethernet, for example. The resulting verbatims are provided to the analysis subsystem 230 for performing the computational analysis on the resulting verbatims in an electronic form stored in the system 230. The results of the analysis are the used by a report generation subsystem 240 to generate resulting reports 250.

FIG. 2A shows an example hardware configuration that might be used to implement the system of FIG. 2. Various user input devices 261-266 can be used to input the verbatims for connecting to the system 270 via a communication network 250, such as the Internet, or by using a computer network such as an Ethernet or cellular network. The user input devices might connect to the network 250 using various communication networks, such as cellular, WiFi, Bluetooth, or Ethernet, for example. In some cases, part or all of the network 250 may be a private network located at the product or service provider location, or it may be a public network or provided by a communication provider such as a cellular system.

The system 270 is comprised of one or more computer servers 272 utilize one or more databases 275 for implementing the various subsystems described above (e.g., with respect to FIG. 2). Note that the subsystems could be implemented using various software modules executing on a single server, or they can be implemented on dedicated servers, or distributed servers, as desired. The methodology is implemented by executing specialized software code, stored in the system (e.g., in databases or system memory or storage devices) on the servers of the system.

Any suitable computer usable (computer readable) medium may be utilized for storing the different specialized software applications that are executed by the system to implement the methodology. The computer usable or computer readable medium may be, for example but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CDROM), cloud storage (remote storage, perhaps as a service), or other tangible optical or magnetic storage device; or transmission media such as those supporting the Internet or an intranet.

The specialized software applications are comprised of computer program code specifically configured for carrying out operations of the example embodiments (i.e., for the smart devices and analysis device(s) of a given system) may be written by conventional means using any computer language, including but not limited to, an interpreted or event driven language such as BASIC, Lisp, VBA, or VBScript, or a GUI embodiment such as visual basic, a compiled programming language such as FORTRAN, COBOL, or Pascal, an object oriented, scripted or unscripted programming language such as Java, JavaScript, Perl, Smalltalk, C++, Object Pascal, C#, Swift, or the like, artificial intelligence languages such as Prolog, a real-time embedded language such as Ada, or even more direct or simplified programming using ladder logic, an Assembler language, or directly programming using an appropriate machine language. Web-based languages such as HTML or any of its many variants may be utilized. Graphical objects may be stored using any graphical storage or compression format, such as bitmap, vector, metafile, scene, animation, multimedia, hypertext and hypermedia, VRML, and other formats could be used. Audio storage could utilize any of many different types of audio and video files, such as WAV, AVI, MPEG, MP3, MP4, WMA, FLAC, MOV, among others. Editing tools for any of these languages and/or formats can be used to create the specialized software.

The computer program instructions of the software and/or scripts comprising the code may be provided to any respective computing device that may interface with the system (e.g., a smartphone, tablet, phablet, PC or other device) which includes one or more programmable processors or controllers, or other programmable data processing apparatus, which executes the instructions via the processor of the computer or other programmable data processing apparatus for implementing the functions/acts specified in this document. It should also be noted that, in some alternative implementations, the functions may occur out of the order noted herein. The software applications can be downloaded to the respective devices in a conventional manner, and could be provided by a software vending site such as an Android or Apple app store, for example.

The specialized software application is installed in the respective computing device (in particular using server(s) and database(s)) for execution that implements the methodology disclosed herein to greatly improve the ability of a computer to analyze natural language responses to a survey to provide meaningful quality information to a provider of products and/or services.

Many other example embodiments can be provided through various combinations of the above described features. Although the embodiments described hereinabove use specific examples and alternatives, it will be understood by those skilled in the art that various additional alternatives may be used and equivalents may be substituted for elements and/or steps described herein, without necessarily deviating from the intended scope of the application. Modifications may be necessary to adapt the embodiments to a particular situation or to particular needs without departing from the intended scope of the application. It is intended that the application not be limited to the particular example implementations and example embodiments described herein, but that the claims be given their broadest reasonable interpretation to cover all novel and non-obvious embodiments, literal or equivalent, disclosed or not, covered thereby.

What is claimed is:

1. A healthcare system designed to discover quality of care and process of care improvement opportunities, and best practices, by collecting patient reported experience of care by use of a computer system including a memory device for storing data and a processor in communication with said memory device, said computer system further including at least one server and at least one database, said computer system processor programmed to perform a method for evaluating the quality of a healthcare service at the micro, meso, and macro levels of care, said method comprising the steps of:
providing a plurality of verbatims as natural language responses obtained from a plurality of patients receiving said healthcare service, each verbatim comprising a response to an open-ended question regarding one patient's personal experience with said healthcare service;
automatically analyzing and segmenting said verbatims into one or more separate logical components, with each segment representing a single discrete thought;
automatically categorizing each discrete thought of said verbatims into one of a plurality of categories based upon topical information contained within each discrete thought;
automatically assigning a numerical value to each discrete thought to give each discrete thought a discrete thought rating;
automatically converting each discrete thought rating to a score;
automatically determining, for each discrete thought, whether the discrete thought is actionable or non-actionable, wherein an actionable discrete thought comprises at least one method, skill, quality, or personal trait experienced by the patient that results in the patient's delight or disappointment with the care received, that can be taught or learned by a healthcare provider of said healthcare service;
automatically determining, for each actionable discrete thought, whether it is a positive actionable discrete thought indicative of said healthcare service exceeding expectations thereby delighting the patient, or a negative actionable discrete thought indicative of said healthcare service not meeting expectations thereby disappointing the patient;
automatically determining a degree to which expectations are met based on the scores of discrete thought determined to be positive actionable discrete thoughts;
automatically determining a likelihood for patients to recommend the healthcare service based upon said determined degree to which expectations are met; and
automatically generating a healthcare report for reporting on the results of the method to thereby enable the healthcare provider of said healthcare service to discover quality and process of care improvement opportunities and what their current performance score is compared to best practices.

2. The healthcare system of claim 1, said method further comprising the step of providing one or more user interfaces to respective patient devices for obtaining said verbatims from the plurality of patients via a communication interface connected to said computer system.

3. The healthcare system of claim 2, said method further comprising the step of converting said verbatims into electronic form.

4. The healthcare system of claim 1, said method further comprising the step of, after automatically categorizing said discrete thoughts, validating and updating the initial categorization of the plurality of discrete thoughts to ensure consistency.

5. The healthcare system of claim 4, said method further comprising the steps of:
providing a second plurality of verbatims obtained from a plurality of patients;
automatically segmenting said second plurality of verbatims into discrete thought;
automatically categorizing said second plurality of discrete thoughts based on the validated and updated categorization; and
automatically assigning a numerical value to each discrete thought of the second plurality of verbatims to give each respective discrete thought a performance rating.

6. The healthcare system of claim 1, said method further comprising the step of identifying drivers of said experience of care of said healthcare service, defined as a most important experience to the patient when receiving care, and a degree of influence of said drivers based on the discrete thought scores, to thereby identify best practices for said healthcare service.

7. The healthcare system of claim 6, wherein said healthcare report reports on the degree of influence of each driver and whether each driver is indicative of said healthcare service exceeding expectations, or indicative of said healthcare service not meeting expectations to thereby result in an opportunity for improvement of said healthcare service.

8. The healthcare system of claim 1, wherein said healthcare report reports on the likelihood of patients to recommend said healthcare provider and further identifies best practices and opportunities for care improvement.

9. The healthcare system of claim 1, wherein said at least one of said categories includes one or more subcategories in which one or more discrete thoughts is categorized.

10. A healthcare system to improve an experience of care comprising a computer system including a memory device for storing data and a processor in communication with said memory device, said computer system further including at least one server and at least one database, said computer system processor programmed to perform a method for evaluating the quality of a healthcare service, said method comprising the steps of:
providing one or more user interfaces for obtaining verbatims, each verbatim comprising a response to an open-ended question regarding one patient's personal experience with said healthcare service, from a plurality of patients;
converting said verbatims into electronic form;
automatically segmenting said verbatims into separate logical components, with each segment representing a discrete thought;
categorizing the discrete thoughts into drivers of patient experience satisfaction;
assigning a numerical value to each discrete thought to give each discrete thought a discrete thought rating;
converting the sum of each discrete thought comprising a driver into a driver score;
identifying drivers of loyalty and their degree of influence based on the driver scores;
for each discrete thought, automatically determining whether the discrete thought is actionable, wherein an actionable discrete thought comprises at least one method, skill, quality, or personal trait that can be taught or learned by a healthcare provider of said healthcare service;
determining a degree in which expectations are met based on the driver scores;
determining a likelihood for patients to recommend the healthcare service based on said degree in which expectations are met.

11. The healthcare system of claim 10, said method further comprising the step of generating a healthcare report for reporting on the categorizations as drivers of the discrete thoughts, their scores and/or their degree of influence, the degree in which patient expectations are met, and a patient's likelihood to recommend.

12. The healthcare system of claim 11, said method further comprising the steps of:
after automatically categorizing said verbatims into discrete thoughts, validating and updating the initial categorization of the plurality of discrete thoughts to ensure consistency by a review by at least two reviewers such that categories are updated and validated based on a statistical analysis of said review;
providing a second plurality of verbatims obtained from a plurality of patients;
automatically segmenting said second plurality of verbatims into discrete thoughts;
automatically categorizing said second plurality of discrete thoughts based on the validated and updated categorization; and
automatically assigning a numerical value to each discrete thought derived from the second plurality of verbatims to give each respective discrete thought a rating.

13. A healthcare system to improve the quality and process of care by evaluating the patient care experience comprising a computer system including a memory device for storing data and a processor in communication with said memory device, said computer system further including at least one server and at least one database, said computer system processor programmed to perform a method for evaluating the quality of a healthcare service, said method comprising the steps of:
providing one or more user interfaces for obtaining verbatims from a plurality of patients, each verbatim comprising a response to an open-ended question regarding one patient's personal experience with said healthcare service;
converting said verbatims into electronic form;
automatically segmenting said verbatims into a subset of discrete thoughts;
initially automatically categorizing the discrete thoughts into drivers of care;
validating and updating the initial categorization of the discrete thoughts to ensure consistency;
automatically segmenting the verbatims not provided in said subset into discrete thoughts;
automatically providing a final categorization of all discrete thoughts based on the validated and updated categorization;
assigning a numerical value to each discrete thought to give each discrete thought a discrete thought rating;
converting each discrete thought rating to a discrete thought score;
identifying drivers of loyalty and their degree of influence based on the discrete thought score;
for each discrete thought, automatically determining whether the discrete thought is actionable, wherein an actionable discrete thought comprises at least one method, skill, quality, or personal trait that can be taught or learned by a provider of said healthcare service;
determining a degree in which patient care expectations are met based on the discrete thought scores;
determining a likelihood for patients to recommend the healthcare service; and
generating a healthcare report for reporting on the discrete thoughts derived from the verbatims, their scores and/or their degree of influence, the degree in which patient expectations are met, a patient's likelihood to recommend, and at least one suggested improvement initiative for the healthcare service based on a best practice and at least one discrete thought that indicated patient care expectations were met in their care experience.

14. The healthcare system of claim 13, wherein said step of validating and updating the initial categorization includes a review by at least two reviewers such that categories are updated and validated based on a statistical analysis of said review.

15. The healthcare system of claim 13, wherein said step of assigning a numerical value to each discrete thought is based at least in part on a measure of delight or disappointment represented by language found in the respective discrete thought.

16. The healthcare system of claim 13, wherein said discrete thought score is calculated using the formula:
PMAS=(5−Rs)×25
where PMAS is the score and Rs is the numerical value assigned to the discrete thoughts.

17. The healthcare system of claim 16, wherein said step of determining a discrete thought score from discrete thoughts which cannot be categorized includes assigning a score based on an average of scores.

18. The healthcare system of claim 13, wherein the step of identifying drivers of loyalty and their degree of influence includes performing a regression analysis on the discrete thought scores.

19. The healthcare system of claim 13, wherein the step of providing one or more user interfaces, for at least some of the patients, is provided using respective patient devices connected to said computer system via a communication network.

20. The healthcare system of claim 1, said method further comprising the step of converting the numerical value assigned to each discrete thought to a non-numerical element to thereby enable displaying each non-numerical element on the healthcare report in a visually intuitive format.
